(19) United States
(12) Patent Application Publication
(10) Pub. No.: US 2013/0345992 A1
(43) Pub. Date: Dec. 26, 2013

(54) METHOD OF DETERMINING THE BREAKING STRESS IN SHEAR OF A PART OF DETERMINED THICKNESS

(71) Applicant: SNECMA, Paris (FR)

(72) Inventor: Jean-Yves Francois Roger CHATELLIER, Arceuil (FR)

(21) Appl. No.: 13/917,227

(22) Filed: Jun. 13, 2013

(30) Foreign Application Priority Data
Jun. 20, 2012 (FR) 12 55796

(51) Int. Cl. G01L 1/10

(52) U.S. Cl. CPC G01L 1/10
USPC 702/43

(57) ABSTRACT

A method of determining the breaking stress in shear for a part of determined thickness and made up of two elements that are bonded together by a layer of adhesive. A plane sensor emits an ultrasound wave at the part of determined thickness. The plane sensor receives a reflected signal made up of a plurality of successive echoes. A processor unit calculates a fast Fourier transform of the reflected signal. A Gaussian envelope connecting together the peaks of all of the resonances of the fast Fourier transform is determined. A frequency at which the Gaussian envelope is at a maximum is determined. The breaking stress from a predetermined correspondence relationship between the frequency of the maximum of the Gaussian envelope and the breaking stress is determined.

### BACKGROUND OF THE INVENTION

The present invention relates to a non-destructive method capable of measuring the breaking stress in shear of an assembly adhesively-bonded on a metallic support.

Conventionally, such a stress is measured by traction tests in shear performed using a traction machine having a measurement cell that is suitable for the material of the test piece under test. The thicknesses of the layers of adhesive and the length of the overlap are measured using a contactless optical measurement machine. The dimensions of the test piece are measured using calipers. Since the thickness of the layer of adhesive may vary depending on the position of the test piece on its support, a plurality of measurements are generally performed on each face and then averaged. The accuracy of the resulting measurement is of the order of 1 micrometer (μm).

Nevertheless, operating in this way presents severe drawbacks. Firstly, the solution that consists in performing a traction test on a test piece is destructive, since the test piece is subjected to stress causing it to break. Consequently, the measurements that are obtained come from a test piece and not from the real part that is to be inspected. The breaking stress is determined on a standardized test piece, i.e. a test piece having dimensions that are not the same as in the real part (which has supports and layers of adhesive that are specific to that part). Furthermore, the nature of the material varies depending on the test pieces, as does the application of the adhesive and the thickness of the final layer of adhesive.

### OBJECT AND SUMMARY OF THE INVENTION

An object of the present invention is thus to mitigate such drawbacks by proposing a non-destructive method of measurement that can be performed directly on the real part.

To this end, there is provided a method of determining the breaking stress in shear for a part of determined thickness e and made up of two elements that are bonded together by a layer of adhesive, the method comprising the following steps:
using a plane sensor to emit an ultrasound wave at a determined nominal frequency towards said part of determined thickness;
using said plane sensor to receive a reflected signal made up of a plurality of successive echoes caused by the ultrasound wave being reflected on various interfaces in said part of determined thickness;
using a processor unit connected to said plane sensor to calculate a fast Fourier transform (FFT) of the reflected signal as obtained in this way;
determining a Gaussian envelope connecting together the peaks of all of the resonances of said fast Fourier transform;
determining a frequency at which said Gaussian envelope is at a maximum; and
determining said breaking stress from a predetermined correspondence relationship between the frequency of the maximum of said Gaussian envelope and the breaking stress as previously recorded in said processor unit.

Thus, since the breaking stress is associated with the ultrasound frequency resonances of the part (which resonances are associated with the quality of the adhesive and co-adhesive bond provided by the adhesive between the two substrates forming the part to be inspected), calculating an FFT of a reflected signal suffices for determining this stress without having recourse to a traction test on the part under inspection.

Preferably, the thickness of said part is obtained prior to emitting said ultrasound wave by means of a micrometer.

Advantageously, said fast Fourier transform is calculated over a spectrum band surrounding a frequency response of said plane sensor and is limited to no more than the first seven echoes of said reflected signal, excluding the first echo that relates to the reflection of the ultrasound wave on the outside face of said part.

Preferably, said frequency of the maximum corresponds to the derivative of a polynomial function passing through the amplitude maximums of said resonance peaks, and obtained by means of a spread sheet.

Advantageously, said correspondence relationship resulting from traction tests performed on various test pieces for which the frequency of the maximum of the Gaussian envelope has been determined, is recorded in said processor unit in the form of a calibration curve or of a table of values.

A particular application of the method of the invention lies in determining the breaking stress in shear of an aluminum TA6V leading edge of a turbine engine blade made of a composite material having an “interlock” weave, by means of a plane sensor having a nominal frequency lying in the range 10 megahertz (MHz) to 25 MHz.

### BRIEF DESCRIPTION OF THE DRAWINGS

Other characteristics and advantages of the present invention appear from the following description made with reference to the accompanying drawings which show an implementation having no limiting character, and in which:

FIG. 1 is a diagrammatic view of a measurement device for implementing the method of the invention for determining breaking stress in shear;

FIG. 2 shows the various steps of the method of the invention for determining breaking stress in shear;

FIG. 3 shows an example of a signal reflected on the part under inspection by the method of the invention for determining breaking stress in shear;

FIG. 4 shows a fast Fourier transform and its Gaussian envelope as obtained from the reflected signal of FIG. 3; and

FIG. 5 shows a calibration curve for determining the breaking stress in shear from the frequency at which the FIG. 4 Gaussian envelope is at a maximum.

### DETAILED DESCRIPTION OF THE INVENTION

FIG. 1 shows the device for performing the non-destructive method of determining the breaking stress due to shear in traction of a leading edge made of TA6V aluminum for a turbine engine blade made of a composite material having an “interlock” wave. Naturally, the method is applicable to any type of part made by an adhesively-bonded assembly.

The real part 10 for inspection is of determined thickness, it is held in a support (not shown), it is made up of two elements 12 and 14 that are secured to each other by a layer of adhesive 16, and it is placed facing an ultrasound sensor 18 connected to a processor unit 20. Advantageously, the sensor is a plane sensor of the V313−15/0.25″ No. 122223 type from the supplier Panametrics that is suitable for emitting a longitudinal ultrasound wave 22 at a nominal frequency of 15 MHz (this frequency typically lying in the range 10 MHz to 25 MHz) from a pulsed signal at 150 volts (V) at the frequency of 1.67 MHz as delivered by a voltage generator of the processor unit.

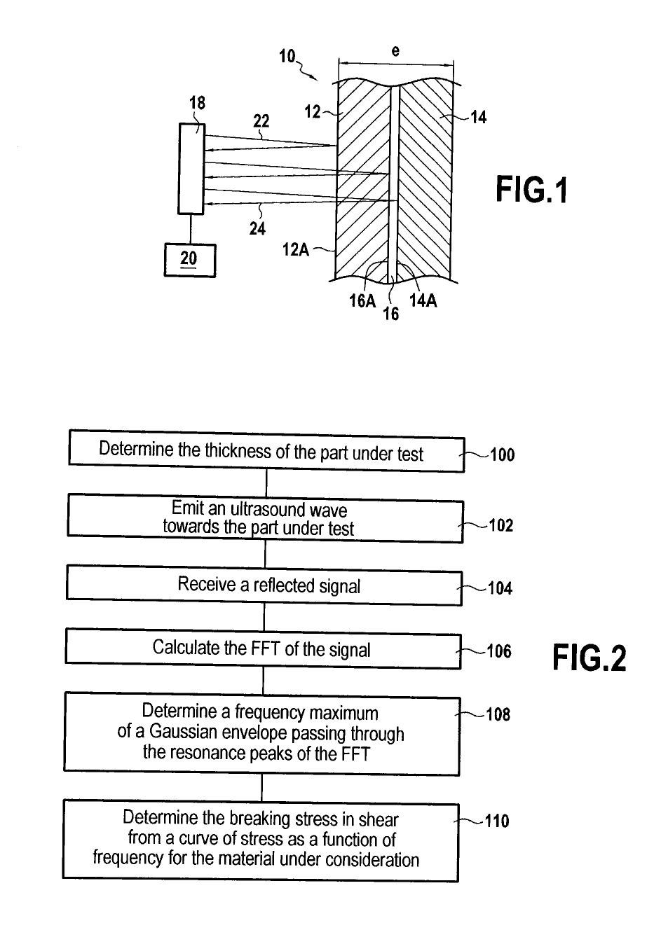

The processor unit 20 also receives the ultrasound wave 24 reflected by the part 10 and processes it in order to deliver a value for breaking stress in shear for that part by performing a measurement method having various steps as shown in FIG. 2.

The first step 100 of these steps consists in measuring the total thickness e of the part 10, which step is preferably performed using a micrometer or calipers (in the example shown, this thickness is e=20.184 millimeters (mm)). In a second step 102, the plane sensor 18 emits a longitudinal ultrasound wave at a predetermined nominal frequency that depends on the material of the part 10, and that is specifically 15 MHz for an aluminum substrate in which the propagation speed is known and equal to 6349.11 meters per second (m/s). This incident wave that is emitted towards the part 10 gives rise to a reflected signal that is received by the plane sensor 18 in a step 104.

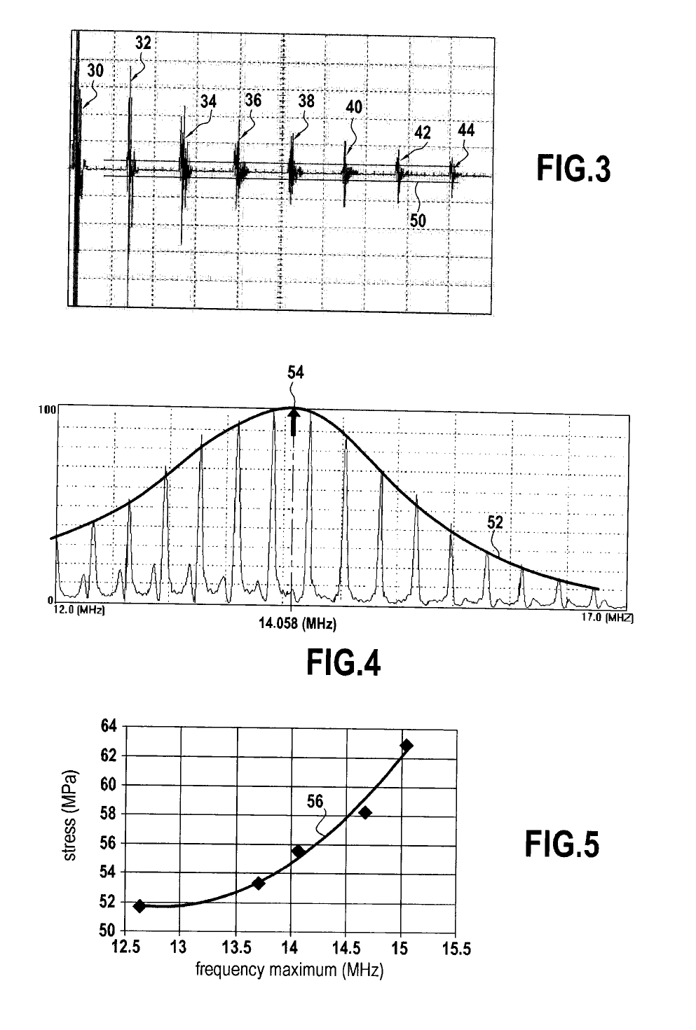

FIG. 3 shows the signal as received in this way, which signal is in the form of a plurality of successive echoes caused by the ultrasound wave being reflected on various interfaces in the part. The first said interface echo 30 corresponds to the incident wave being reflected on the entry face 12A of the part 10. The second echo 32 corresponds to the fraction of the transmitted wave that reaches the interface 16A with the layer of adhesive 16. Successive reflections in the adhesive are invisible at this wavelength of more than 600 pm. The third echo 34 and the following echoes 36-44 are of shapes that are more complex and are the result of superposing multiple reflections that depend in particular on the respective thicknesses of the materials through which the wave passes.

In a following step 106, the processor unit 20 calculates an FFT of the reflected signal as obtained in this way. This transform is shown in FIG. 4 over a spectrum band lying in the range 12.5 MHz to 17.5 MHz around the frequency response of a plane sensor with a nominal frequency of 15 MHz (maximum amplitude response). There can be seen therein a set of resonances and a secondary envelope revealing secondary Gaussians corresponding to resonances in the layer of adhesive 16. Thus, the layer of adhesive, which is not visible from the echoes in the reflected signal, nevertheless appears clearly after calculating the fast Fourier transform of the signal. Returning to FIG. 3, there can be seen a diagrammatic representation of the “gate” function 50 that limits the portion of the signal analyzed by the fast Fourier transform to only the first seven echoes reflected in the material 32-44, excluding the first interface echo 30 associated with the wave traveling outside the material.

In a new step 108, and on the basis of the fast Fourier transform, a frequency is then determined at which the Gaussian curve (Gaussian envelope 52) passing via the resonance peaks of the transform is at a maximum. In practice, it is possible to read off the amplitude maximums, and then to make use of a spread sheet, e.g. of the Excel type, to determine the polynomial function that passes through the maximums. The derivative of the resulting function gives accurately the value 54 of the looked-for frequency.

Finally, in a final step 110, the looked-for breaking stress in shear is obtained from a correspondence relationship that is prerecorded in the processor unit 20, e.g. in the form of a calibration curve 56 or in the form of a table of values, giving the value for this stress as a function of the frequency of the maximum of the Gaussian envelope as determined in the preceding step. Thus, in the example shown, a frequency of 14.058 MHz corresponds to a breaking stress of 55.5 megapascals (MPa). This table of values, or the calibration curve from which it is generated, is obtained previously in conventional manner by traction tests performed on various test pieces of known thickness and for which the frequency of the maximum of the Gaussian envelope passing through the resonance peaks has already been measured using the above method.

Thus, in the invention, it becomes possible to obtain the value of the breaking stress for an adhesively-bonded assembly in a manner that is fast and non-destructive, and this result is obtained directly on the part for inspection and not on a test piece that is merely representative thereof, regardless of the thickness of the layer of adhesive, thereby making the inspection method of the invention most valuable.

What is claimed is:

1. A method of determining the breaking stress in shear for a part of determined thickness e and made up of two elements that are bonded together by a layer of adhesive, the method comprising the following steps:
using a plane sensor to emit an ultrasound wave at a determined nominal frequency towards said part of determined thickness;
using said plane sensor to receive a reflected signal made up of a plurality of successive echoes caused by the ultrasound wave being reflected on various interfaces in said part of determined thickness;
using a processor unit connected to said plane sensor to calculate a fast Fourier transform of the reflected signal as obtained in this way;
determining a Gaussian envelope connecting together the peaks of all of the resonances of said fast Fourier transform;
determining a frequency at which said Gaussian envelope is at a maximum; and
determining said breaking stress from a predetermined correspondence relationship between the frequency of the maximum of said Gaussian envelope and the breaking stress as previously recorded in said processor unit.

2. A method according to claim 1, wherein said determined thickness of said part is obtained prior to emitting said ultrasound wave by means of a micrometer.

3. A method according to claim 1, wherein said fast Fourier transform is calculated over a spectrum band surrounding a frequency response of said plane sensor.

4. A method according to claim 1, wherein the calculation of said fast Fourier transform is limited to no more than the first seven echoes of said reflected signal, excluding the first echo that relates to the reflection of the ultrasound wave on the outside face of said part.

5. A method according to claim 1, wherein said frequency of the maximum corresponds to the derivative of a polynomial function passing through the amplitude maximums of said resonance peaks, and obtained by means of a spread sheet.

6. A method according to claim 1, wherein said correspondence relationship is recorded in said processor unit in the form of a calibration curve or of a table of values.

7. A method according to claim 6, wherein said correspondence relationship results from traction tests performed on various test pieces for which the frequency of the maximum of the Gaussian envelope has been determined.

8. An application of the method according to claim 1, in determining the breaking stress in shear of an aluminum TA6V leading edge of a turbine engine blade made of a composite material having an “interlock” weave, by means of a plane sensor having a nominal frequency lying in the range 10 MHz to 25 MHz.
